(19) United States
(12) Patent Application Publication
(10) Pub. No.: US 2024/0020336 A1
(43) Pub. Date: Jan. 18, 2024

(54) SEARCH USING GENERATIVE MODEL SYNTHESIZED IMAGES

(71) Applicant: Loop Now Technologies, Inc., San Mateo, CA (US)

(72) Inventors: Wu-Hsi Li, Somerville, MA (US); Hong-Ming Tseng, Toronto (CA)

(73) Assignee: Loop Now Technologies, Inc., San Mateo, CA (US)

(21) Appl. No.: 18/220,346

(22) Filed: Jul. 11, 2023

Related U.S. Application Data
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/443,063, filed on Feb. 3, 2023.
(60) Provisional application No. 63/438,011, filed on Jan. 10, 2023.
(60) Provisional application No. 63/437,397, filed on Jan. 6, 2023.
(60) Provisional application No. 63/431,757, filed on Dec. 12, 2022.
(60) Provisional application No. 63/430,372, filed on Dec. 6, 2022.
(60) Provisional application No. 63/424,958, filed on Nov. 14, 2022.
(60) Provisional application No. 63/423,128, filed on Nov. 7, 2022.
(60) Provisional application No. 63/414,604, filed on Oct. 10, 2022.
(60) Provisional application No. 63/413,272, filed on Oct. 5, 2022.
(60) Provisional application No. 63/395,370, filed on Aug. 5, 2022.
(60) Provisional application No. 63/388,270, filed on Jul. 12, 2022.
(60) Provisional application No. 63/522,205, filed on Jun. 21, 2023.
(60) Provisional application No. 63/524,900, filed on Jul. 4, 2023.

(51) Int. Cl. G06F 16/738; G06F 16/783; G06F 16/735

(52) U.S. Cl. CPC G06F 16/738; G06F 16/7844; G06F 16/735

(57) ABSTRACT

Disclosed embodiments provide techniques for search using generative model synthesized images. An image, or set of images, is generated based on a text query, and the generated image or images are used as input to an image-based search query. In some instances, this technique provides more comprehensive and effective search results. In cases where a user wishes to search for something for which no known image currently exists, disclosed embodiments can provide more effective results than a text-based query. Disclosed embodiments generate an input image based on the text query using generative model synthesized image techniques. The input image is used to perform an image-based search, and sorted results are returned. Disclosed embodiments are particularly useful when searching for visual art in the form of images and/or videos.

### RELATED APPLICATIONS

This application claims the benefit of U.S. provisional patent applications “Search Using Generative Model Synthesized Images” Ser. No. 63/388,270, filed Jul. 12, 2022, “Creating And Populating Related Short-Form Video Segments” Ser. No. 63/395,370, filed Aug. 5, 2022, “Object Highlighting In An Ecommerce Short-Form Video” Ser. No. 63/413,272, filed Oct. 5, 2022, “Dynamic Population Of Contextually Relevant Videos In An Ecommerce Environment” Ser. No. 63/414,604, filed Oct. 10, 2022, “Multi-Hosted Livestream In An Open Web Ecommerce Environment” Ser. No. 63/423,128, filed Nov. 7, 2022, “Cluster-Based Dynamic Content With Multi-Dimensional Vectors” Ser. No. 63/424,958, filed Nov. 14, 2022, “Text-Driven AI-Assisted Short-Form Video Creation In An Ecommerce Environment” Ser. No. 63/430,372, filed Dec. 6, 2022, “Temporal Analysis To Determine Short-Form Video Engagement” Ser. No. 63/431,757, filed Dec. 12, 2022, “Connected Television Livestream-To-Mobile Device Handoff In An Ecommerce Environment” Ser. No. 63/437,397, filed Jan. 6, 2023, “Augmented Performance Replacement In A Short-Form Video” Ser. No. 63/438,011, filed Jan. 10, 2023, “Livestream With Synthetic Scene Insertion” Ser. No. 63/443,063, filed Feb. 3, 2023, “Dynamic Synthetic Video Chat Agent Replacement” Ser. No. 63/447,918, filed Feb. 24, 2023, “Synthesized Realistic Metahuman Short-Form Video” Ser. No. 63/447,925, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, and “Text-Driven Video Editing With Machine Learning” Ser. No. 63/524,900, filed Jul. 4, 2023.

Each of the foregoing applications is hereby incorporated by reference in its entirety.

### FIELD OF ART

This application relates generally to computer searching and more particularly to search using generative model synthesized images.

### BACKGROUND

The Internet contains an amazingly large amount of information and continues to grow. It is evident that the amount of global data is enormous and will continue to grow enormously. A considerable portion of the global data is embodied in images and videos. Among the videos on the Internet, a considerable portion of them are short-form videos. Short-form videos are gaining popularity. Individuals are now able to consume short-form video from almost anywhere on any connected device at home, in an airport, or even walking outside. Especially on mobile devices, social media platforms have become an extremely common use of internet-based video. Accessed through the use of a browser or specialized app that can be downloaded, video access has become easy. Today's mobile devices can support on-device editing through a variety of applications (“apps”). The on-device editing can include splicing and cutting of video, adding audio tracks, applying filters, and the like. Furthermore, modern mobile devices are typically connected to the Internet via high-speed networks and protocols such as WiFi, 4G/LTE, 5G/OFDM, and beyond. Each time network speed and bandwidth has improved, devices and technologies have been created to introduce new capabilities. A variety of Internet protocols, such as HTTP Live Streaming (HLS), Real-Time Messaging Protocol (RTMP), Web Real-Time Communications (WebRTC), and Secure Reliable Transport (SRT), to name a few, enable unprecedented amounts of video sharing. The videos can include news, product discussion, educational, entertainment, and how-to videos, and videos which discuss and promote various products.

Advances in mobile devices, coupled with the connectivity and portability of these devices, enable high-quality video capture, and fast uploading of video to these platforms. Thus, it is possible to create virtually unlimited amounts of high-quality content that can be quickly shared with online communities. These communities can range in size from a few members to millions of individuals. Social media platforms and other content-sharing sites can utilize short-form videos for entertainment, news, advertising, product promotion, and more. Short-form videos give content creators an innovative way to showcase their creations. Leveraging short-form videos can encourage audience engagement, which is of particular interest in product promotion. Users spend many hours online watching an endless supply of videos from friends, family, social media “influencers”, gamers, news sites, favorite sports teams, or from a plethora of other sources. The attention span of many individuals is limited. Studies show that short-form videos are more likely to be viewed to completion as compared with longer videos. Hence, the short-form video is taking on a new level of importance in areas such as e-commerce, news, and general dissemination of information.

The advent of short-form video has contributed to the amount of global data on the Internet. As technologies improve and new services are enabled, the amount of global data available, and the rate of consumption of that data, will only continue to increase.

### SUMMARY

Search engines can include three main functions: ingesting, indexing, and ranking. Ingesting can include web crawling to locate and scrape website content. A scheduling component keeps track of the intervals in which the websites are to be reviewed for new updates. Information from the websites is extracted and parsed, and the scheduling component, using a number of different factors, determines how often a website needs to be reviewed and crawled again. The indexing can include placing information from ingested websites into an indexed database. The indexed database can include URLs, keywords, images, and other information. The database may contain billions of records for various webpages. In some cases, the indexed database may even contain cached data from previous versions of webpages, allowing users to perform historical searches. Another important aspect of search engines is their ranking capabilities. Search engines can provide sorted and/or ranked results. Searches can be ranked on topical relevance, based on keywords used in a search query. Ranking can also include criteria beyond keywords, such as geographic location information, user preferences, language, average webpage loading time, and/or other factors. Many users submit text-based search queries to a search engine. As an example, a user wishing to find information about sunglasses may enter a search query such as “impact resistant sunglasses” and would expect a list of websites pertaining to sunglasses. The websites can be e-commerce retailers, blogs about sunglasses, vlogs about sunglasses, and the like.

Another form of searching is image-based searching. With image-based searching, an image is used as the query, instead of text. As an example, in a text-based query, a user can enter the word “flowers” as a text query into a search engine, and the search engine can return images that are tagged with metadata indicating that they are images of flowers. In contrast, with an image-based search, a user can provide an image of a flower, and based on the input image, the search engine can return similar images. With image-based searching, the input image may be analyzed for features such as textures, colors, lines, shapes, edges, shadows, and other distinctive features. Those features are then compared with other images deemed to be similar, and those images are returned as the results. Content Based Image Retrieval (CBIR) technology can be used to obtain image-based search results. An interesting point about searching is that an image-based search may return different results than a text-based search. As an example, a text-based search for “pink flower” may return different images than an image-based search in which the input image shows a pink flower.

Disclosed embodiments provide techniques for search using generative model synthesized images. In embodiments, a user enters a text-based search query. An image or set of images is generated based on the text query, and the generated image or images are used as input to an image-based search query. This technique can provide more comprehensive and effective search results. In particular, users may wish to search for something for which no known image currently exists. In these instances, disclosed embodiments may provide more effective results than a text-based query. As an example, a user may enter a text query for retrieving images of a cat with zebra stripes standing near a fire hydrant. Disclosed embodiments may generate an input image based on the text query using generative model synthesized image techniques. The input image is then used to perform an image-based search, and results are returned to the user. Disclosed embodiments are particularly useful when searching for fantastical or less tangible concepts. The retrieved search results may not be an exact match, but rather may bear some similarity to the text-based search query. While this type of search is unlikely to be used for a tangible concept (e.g., a bus schedule for Detroit), disclosed embodiments are very effective for searching for things such as visual art (e.g., a dog in zebra stripes driving a motorcycle) in the form of images and/or videos.

A computer-implemented method for searching is disclosed comprising: accessing a library of short-form videos; obtaining, from a user, a query for a short-form video based on a textual description; synthesizing an image, to create a synthesized image, using a generative model, wherein the synthesizing is based on the obtaining; searching the library of short-form videos for the short-form video that corresponds to the synthesized image; and presenting, to the user, the short-form video from the library that corresponds to the query. In embodiments, the generative model is based on a generative adversarial network (GAN), a variational autoencoder (VAE), a flow-based model, an autoregressive model, or latent diffusion. In embodiments, the synthesizing is based on an artificial intelligence (AI) model, and the training of the AI model is based on results of previous queries. In embodiments, the previous queries include different users. In embodiments, the synthesizing includes creating a second synthesized image based on the generative model. Some embodiments comprise selecting, by the user, between the synthesized image and the second synthesized image, and the searching is based on the selecting. Some embodiments comprise evaluating results of searches based on the synthesized image and the second synthesized image.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for search using a generative model synthesized image.

FIG. 2 is a flow diagram for search using multiple generative model synthesized images.

FIG. 3 shows examples of generative model usage.

FIG. 4 is an infographic for search using a generative model synthesized image.

FIG. 5 is an infographic for search with user selection.

FIG. 6 is an infographic for search based on video.

FIG. 7 is an infographic for search based on picture sequence.

FIG. 8 is an infographic for training an improving engine.

FIG. 9 is a system diagram for search using a generative model synthesized image.

### DETAILED DESCRIPTION

Techniques for search using generative model synthesized images are disclosed. A text query is obtained. A synthesized image is generated, based on the text query. The synthesized image is then used as an input image to an image-based search. The results of the image-based search are then provided to a user. The results may be sorted and/or ranked based on one or more criteria. In some embodiments, multiple input images are generated. In some embodiments, a user can select which synthesized image or images are used for performing an image-based search. In this way, the user can select a synthesized image that most closely resembles the concept the user wants to search for. In some embodiments, the synthesized image may not be shown to the user, and instead may be fed directly to an image-based search engine for retrieving images and/or videos that are deemed related to the synthesized image.

Certain search topics are well suited to text-based searching. An example of such a topic is movie showtimes for a specific movie. Other topics, such as searching for images and/or videos containing artistic elements, are well suited to image searching. The problem is that in some situations, a user has the words to describe a concept, (e.g., a bird wearing a hat), but corresponding images do not exist. Disclosed embodiments utilize generative models to synthesize images that correspond to the text query. Those images are then used to perform an image-based search, retrieve images and/or videos that are sorted and/or ranked, and provide results to a user. The videos can be short-form videos. Thus, disclosed embodiments enable new ways to search through the ever-growing number of short-form videos.

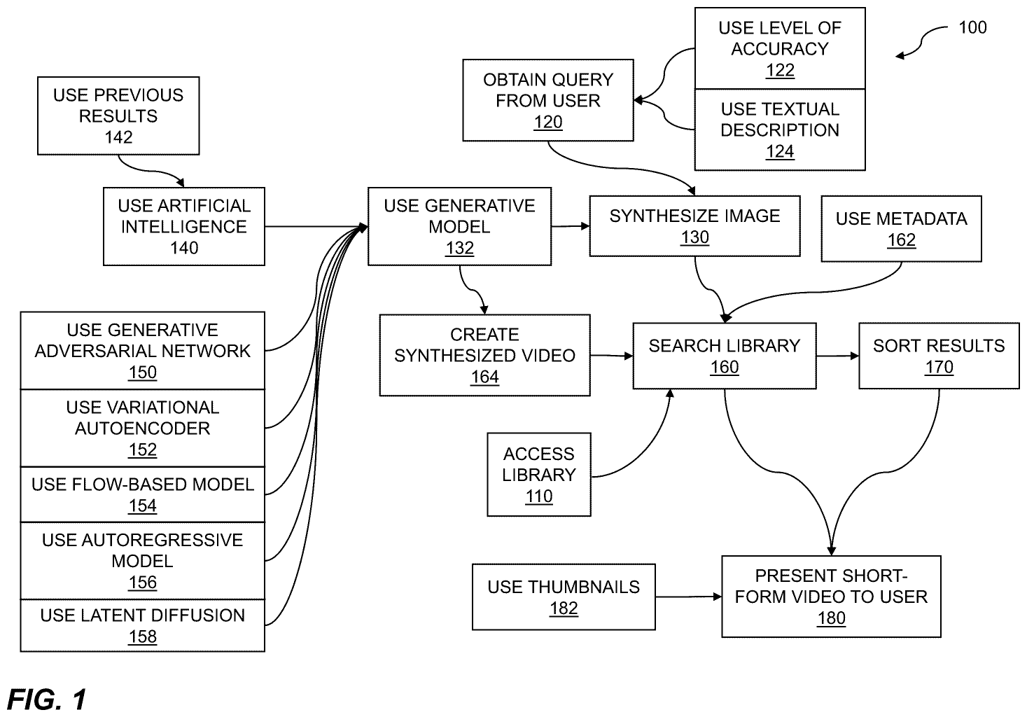

FIG. 1 is a flow diagram 100 for search using a generative model synthesized image. The flow includes obtaining a query from a user 120. The query can be a text-based query. The query can include multiple words. In embodiments, natural language processing, entity detection, spellchecking, and/or other suitable processes may be performed on the text query. The flow can include use of a textual description 124. The textual description can be for something non-reality based (e.g., an elephant playing a trombone while riding a unicycle). The flow can include using a level of accuracy 122. The level of accuracy and the textual description may together form the basis of a query to a user. In embodiments, the level of accuracy is a numerical parameter. In some embodiments, the level of accuracy ranges from zero to 100, with a higher number being more accurate. Some embodiments may include additional parameters besides a level of accuracy. Some embodiments may include a parameter for the number of images to generate. Some embodiments may include a diversity factor. When multiple images are selected to be generated, the diversity factor is a measure of how different the generated images should be from each other. In some embodiments, an image size parameter may also be included. The image size parameter can include a measure of image size, in pixels and/or bytes, to be generated.

In embodiments, the synthesized images are created using a generative model 132. Generative models are a class of statistical models that can generate new data instances. In some embodiments, the generative model includes a generative adversarial network (GAN) 150. A generative adversarial network (GAN) includes two parts. A generator learns to generate plausible data. The generated instances are input to a discriminator. The discriminator learns to distinguish the generator's fake data from real data. The discriminator penalizes the generator for generating implausible results. During the training process, over time, the output of the generator improves, and the discriminator has more success distinguishing real output from fake output. The generator and discriminator can be implemented as neural networks, with the output of the generator connected to the input of the discriminator. Embodiments may utilize backpropagation to create a signal that the generative neural network uses to update its weights.

The discriminator may utilize training data coming from two sources, real data, which can include images of real objects (people, dogs, motorcycles, etc.), and fake data, which are images created by the generator. The discriminator uses the fake data as negative examples during the training process. A discriminator loss function is used to update weights via backpropagation for discriminator loss when it misclassifies an image.

The generator learns to create fake data by incorporating feedback from the discriminator. Essentially, the generator learns how to “trick” the discriminator into classifying its output as real. A generator loss function is used to penalize the generator for failing to trick the discriminator. Thus, in embodiments, the generative adversarial network (GAN) includes two separately trained networks. In embodiments, the discriminator neural network is trained first, followed by training the generative neural network, until a desired level of convergence is achieved.

In some embodiments, the generative model includes a variational autoencoder (VAE) 152. The VAE is an autoencoder with an encoding distribution that is regularized during the training in order to ensure that its latent space has good properties for generation of new data. An autoencoder includes an encoder and a decoder in series to perform dimensionality reduction. The VAE encodes input as a distribution over latent space, and utilizes backpropagation based on reconstruction error induced by the decoder. Thus, variational autoencoders (VAEs) are autoencoders that address the problem of the latent space irregularity by making the encoder return a distribution over the latent space instead of a single point, and by incorporating in the loss function a regularization term over that returned distribution in order to ensure a better organization of the latent space.

In some embodiments, the generative model includes a flow-based model 154. Flow-based models can provide the capabilities of density calculation and sampling. After learning a mapping between probability distributions, flow-based models can exactly compute the likelihood that any given sample was drawn from the target distribution. They can also generate new samples from the target distribution.

In some embodiments, the generative model includes an autoregressive model 156. An autoregressive model is a time-series model that describes how a particular variable's past values influence its current value. That is, an autoregressive model attempts to predict the next value in a series by incorporating the most recent past values and using them as input data. In some embodiments, the generative model includes latent diffusion 158. Latent diffusion models can accelerate diffusion by operating in a lower-dimensional latent space. Latent diffusion models may have a more stable training phase than GANs and may have less parameters than autoregressive models.

Embodiments include synthesizing an image 130. The synthesized image can be created using one of the aforementioned techniques. In some embodiments, multiple synthesized images are created. In some embodiments, the multiple synthesized images form a sequence. In some embodiments, many synthesized images are formed in a sequence to create synthesized video 164 that can be used as an input to an image-based search.

The flow includes accessing a library 110. The library can include a plurality of still images, such as those stored in bitmap, JPEG, or another suitable format. The library can include a plurality of videos. The videos can be stored in an MPEG-4 format, or another suitable format. The videos can include short-form videos. The flow includes searching the library 160, based on the synthesized image 130 and/or synthesized video 164. The searching can further include using metadata 162. The metadata can be used to augment the image search. The metadata can include a text description, geographic location information, creation date, authorship, and/or other metadata. In some embodiments, the metadata includes hashtags, repost velocity, user attributes, user history, ranking, product purchase history, view history, or user actions.

Embodiments utilize content-based image retrieval (CBIR), with generative model synthesized images as the input. In embodiments, one or more image descriptors may be obtained from the synthesized image. The image descriptors can include, but are not limited to, color, shape, and texture. The CBIR may utilize a library that has been analyzed a priori to perform feature extraction, so that the features can be compared for similarity during the image-based search process. Feature extraction can be performed globally, using bounding boxes that define rectangular regions within an image, a binary mask, or other suitable techniques. In some embodiments, a similarity metric may be obtained. The similarity metric can include, but is not limited to, a Euclidean distance, a cosine distance, and/or a chi-squared distance. The search results include the images deemed to be most similar, based on the similarity function.

The flow can include sorting the results 170. In embodiments, the results may be sorted based on metadata. The sorting can also be based on other criteria provided by the search engine. This can include, but is not limited to, matching of features based on image classifiers, identification of objects, probability of classification of objects, and so on. The flow can include presenting a short-form video to the user 180, based on the results of the image-based search. The flow can include using thumbnails 182 to display the results. The thumbnails can be images and/or video clips from the short-form video.

The flow can include using previous search results 142 as input to create a new synthesized image. Thus, embodiments can include an iterative search process based on synthesized input images from a text-based search query. One or more images from a first search may be input back into the image-based search engine to continue searching for similar images and/or videos. In embodiments, artificial intelligence 140 is used to refine the previous results, and to filter out images that may not be a good match for the search query. In embodiments, the search results include short-form videos. The short-form videos can be displayed using a video player executing on a device. The videos can be displayed within a frame or a window associated with the video player. The displaying the video can be accomplished using an app, a window associated with a web browser, and the like.

In embodiments, the generative model is based on a generative adversarial network (GAN), a variational autoencoder (VAE), a flow-based model, an autoregressive model, or latent diffusion. In embodiments, the synthesizing is based on an artificial intelligence (AI) model. In embodiments, training of the AI model is based on results of previous queries. In some embodiments, the previous queries include different users. In embodiments, the searching includes metadata. In some embodiments, an automated or semi-automated search can be performed to augment contents of a website or internet article. The website or internet article can be analyzed and a search query can be generated based on such an article. The query can be based on natural language processing of material in the article or video/audio associated with the article. An image can be based on the article or extracted from the article for searching the library. Results of a library search, based on the query, can be presented as an image or video adjacent to or within the presented article. This search and presentation can be updated occasionally on a periodic basis or as the article is updated. The video can be a snippet or portion of the overall video that was found during the search or can be the entire video. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

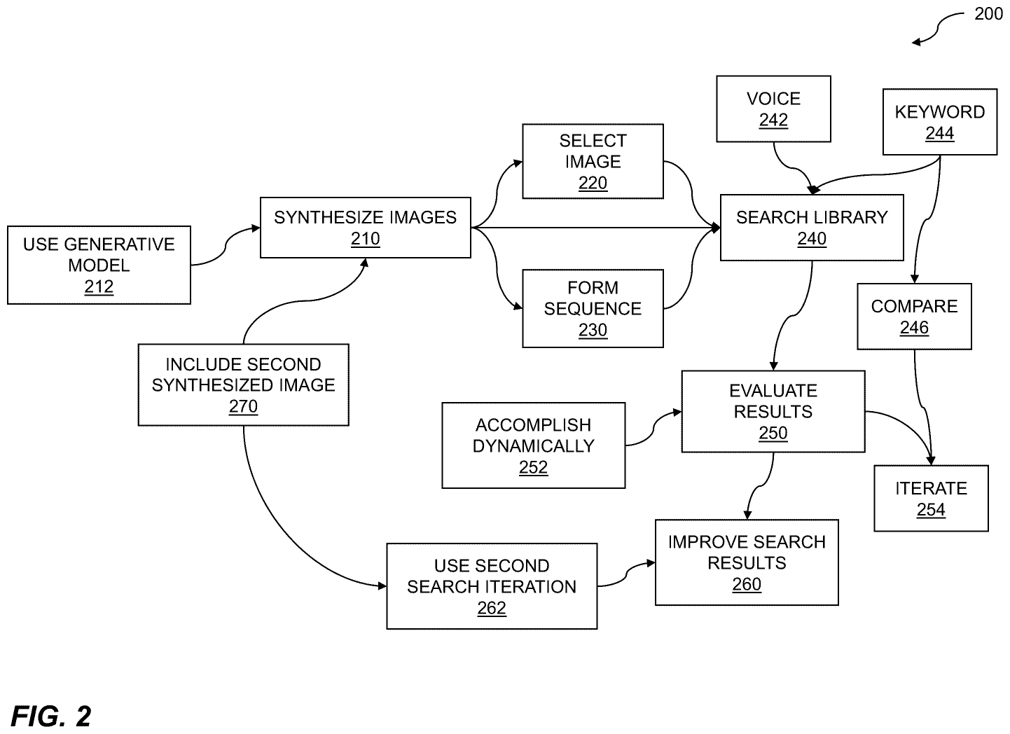

FIG. 2 is a flow diagram 200 for search using multiple generative model synthesized images. The flow includes synthesizing multiple images 210. In embodiments, the images can be synthesized using a generative model 212. The generative model can include a generative adversarial network (GAN), a variational autoencoder (VAE), a flow-based model, an autoregressive model, latent diffusion, or some other suitable technique now known or one that will be developed in the future. The flow can include selecting an image 220. In embodiments, multiple images are generated based on a text input query. The user can then select an image or images from amongst the generated images that the user feels best represent the concept being searched. The flow continues with searching the library 240. The library can contain short-form videos, livestream videos, livestream replays, video frames, images, and/or other multimedia files. Such a library can be a proprietary library, a common library, or a third-party media library. In some cases, a plurality of libraries is searched. In embodiments, a textual keyword search 244 of the library is performed. Results of the text-based search can be compared 246 to results from the image-based search performed after the selecting of the image 220. In some cases, such a comparison is referred to as a “diff”. Such a diff can be used to improve further searches. In some embodiments, a voice-based search can be performed. In this case, a query is generated by voice entry 242. A user can describe a desired image or video by speech. Such a voice-generated query can be a few words, a sentence, a 30 second entry, or an entry of some other arbitrary length. The flow continues with evaluating results 250. The evaluating can include a user's ranking and/or selecting search result items that the user liked. The results may be accomplished dynamically 252. When a user selects images, the results may be updated/refreshed in real time as images are being selected. Results of the text-based versus the image-based searches, and the resulting comparison, can be used to iterate 254 on the desired image or videos returned for further searches. A second, third, or further subsequent library search 240 can be performed.

The flow can include improving search results 260. The improving can be based on the evaluating results 250. The selected items can then be used to train machine learning models. The selected items can include a second synthesized image 270. The second synthesized image can be used in a second search iteration 262. In embodiments, the second synthesized image is generated using the same model as the first synthesized image. In some embodiments, the second synthesized image is generated using a different model than what was used to generate the first synthesized image. In embodiments, the first synthesized image is generated using a generative adversarial network (GAN), and the second synthesized image is generated using a variational autoencoder (VAE). The process depicted in FIG. 2 can be repeated multiple times to obtain satisfactory search results.

In embodiments, the multiple synthesized images can be used to form a sequence 230. The sequence can include two or more images. The images may have a temporal relationship. The images can show a first scene morphing into a second scene. The images can be part of a video. The sequence can include temporal activity. As an example, the sequence can include a cat approaching a fountain. A first image can show a cat two meters from a fountain, a second image can show a cat one meter from a fountain, and so on.

In embodiments, the synthesizing includes creating a second synthesized image based on the generative model. Embodiments can include selecting, by the user, between the synthesized image and the second synthesized image. In embodiments, the searching is based on the selecting. Embodiments can include evaluating results of searches based on the synthesized image and the second synthesized image. In embodiments, the evaluating is accomplished dynamically. In embodiments, the presenting is based on the evaluating. In embodiments, the searching includes correspondence to a second synthesized image. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

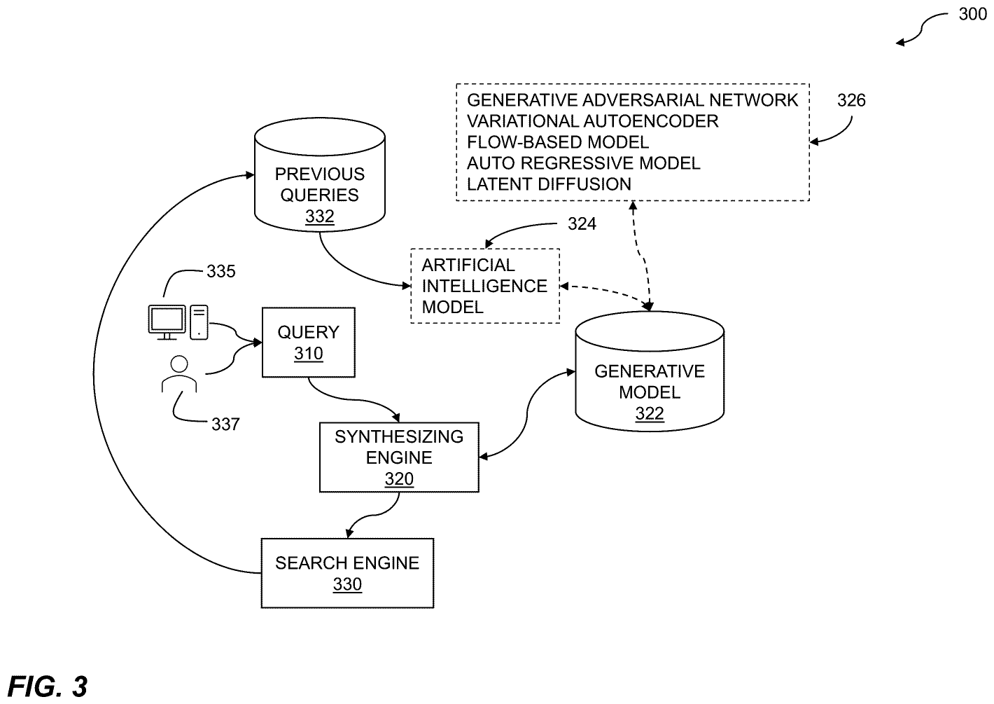

FIG. 3 shows an example 300 of generative model usage. A user submits a query 310. The user can include a person 337. In embodiments, the user can be a computer system 335. The computer system 335 may be operating an artificial intelligence model 324 for selecting text search queries. The text search queries are converted into images by the synthesizing engine 320. The synthesizing engine can use a generative model 322. A generative model 322 utilizes one or more image generating models 326. The models can include, but are not limited to, a generative adversarial network, a variational autoencoder, a flow-based model, an autoregressive model, and/or latent diffusion. The artificial intelligence model 324 may utilize previous search queries 332 to train the artificial intelligence model. Embodiments can include improving search results, wherein the improving is based on a second search iteration with the presented short-form video. In embodiments, the second search iteration includes a second synthesized image based on the generative model. The search engine 330 uses the output of the synthesizing engine 320 to perform a search within a short-form video library. The results of the search may be stored for future use, as previous search queries.

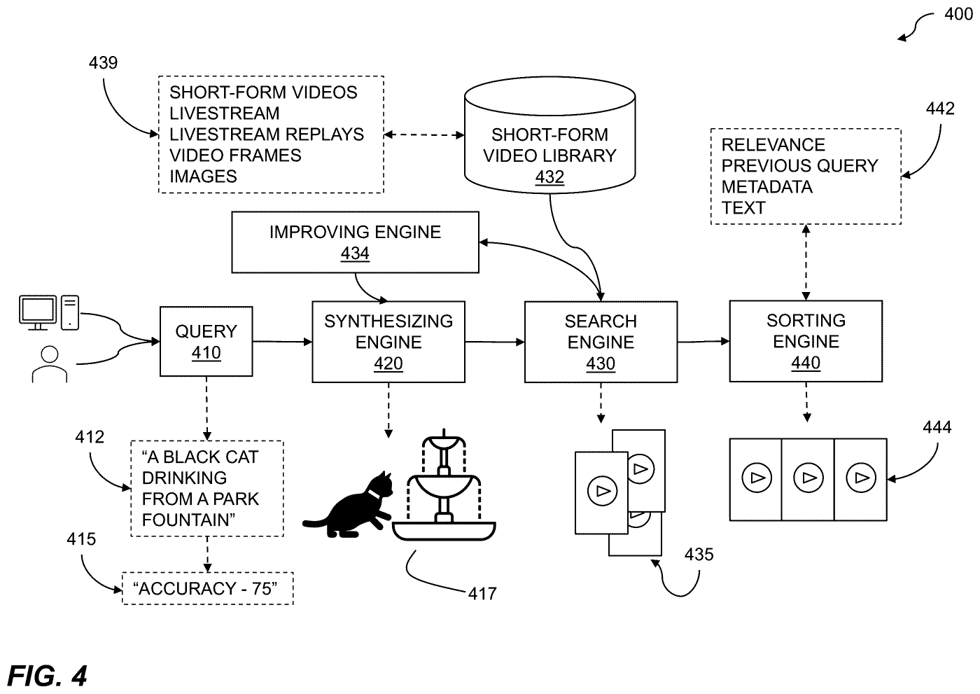

FIG. 4 is an infographic 400 for search using a generative model synthesized image. A user inputs a query 410. The query can be a text-based query. An example query 412 is shown which states, “A black cat drinking from a park fountain.” An accuracy 415 can be included in the query. The accuracy can be a numeric value indicating how similar the images are to the text query. In embodiments, the text query is analyzed via natural language processing to extract tokens and classify them as nouns, adjectives, verbs, and “miscellaneous”. Miscellaneous tokens may be ignored and not considered in the search process. In embodiments, the accuracy level is applied via an input query tokenization technique, in which the accuracy level is a percentage that indicates how many tokens must be found in an image to be considered. As an example, the accuracy level specified at 415 is 75. The text query 412 contains the following tokens that are used for analysis: black, cat, drinking, park, fountain. With an accuracy level of 75, an image that matches 75 percent of the tokens may be accepted. As there are five analyzable tokens in this example, 75 percent of 5 is 3.75. In embodiments, the result is rounded to the nearest integer, which in this example, 3.75 rounds to 4, meaning that four of the five tokens must be present in an image in order for it to be included in the search results. The presence of the tokens in the image may be performed via machine learning systems utilizing image classifiers and/or object detectors to perform object recognition. Other techniques for applying the accuracy field may be use instead of, or in addition to, the aforementioned tokenization technique. The object detectors can include, but are not limited to, R-CNN (Regions with Convolutional Neural Networks), Fast R-CNN, SSD (Single Shot Detector), and YOLO (You Only Look Once).

The synthesizing engine 420 creates an image using a generative model, as previously described. In this example, the image 417 is of a cat approaching a fountain. The search engine 430 uses the output of the synthesizing engine 420 (the image 417) to perform a search within the short-form video library 432. The short-form video library has contents 439 which can include, but are not limited to, short-form videos, livestream videos, livestream replay videos, video frames, images, emojis, symbols, audio files, and/or other multimedia files. The delivery of content from the short-form video library 432 can be via any suitable network protocols, including, but not limited to, TCP, UDP, HTTP Live Streaming (HLS), Real-Time Messaging Protocol (RTMP), Web Real-Time Communications (WebRTC), Secure Reliable Transport (SRT), and/or other suitable protocols. The video can be delivered via unicast, multicast, or broadcast. Multicast is a one-to-many and many-to-many communication protocol that reduces network traffic when transmitting large amounts of data. Bandwidth optimization occurs because it delivers one single version of a data file, such as a livestream video, to hundreds or thousands of users simultaneously.

The output of the search engine 430 is multiple short-form videos 435. The short-form videos 435 are unsorted. The output of the search engine 430 is input to the sorting engine 440. The sorting engine 440 outputs the short-form videos 444 in a sorted manner. The sorting can be in a list, thumbnail grid, and/or another suitable representation. The thumbnails can be static thumbnails or video thumbnails. In embodiments, the sorting can be based on various criteria 442. The criteria can include, but is not limited to, text, metadata, a previous query, and/or relevance. The text can include text within the short-form videos that is recognized via an optical character recognition (OCR) process. The metadata can include descriptive data associated with a short-form video. The relevance can be based on image characteristics such as colors, shapes, and other features within images within the short-form video.

In some embodiments, every frame within a short-form video is searched to compare against the input image created by the synthesizing engine 420. In some embodiments, to save time, only certain frames within a short-form video are searched. In embodiments, only intra-coded (I-frames) are searched. In embodiments, each short-form video in the short-form video library 432 is indexed at periodic intervals (e.g., every five seconds) with a corresponding image from the short-form video also stored within the short-form video library. This indexing can be performed upon ingest of a video asset. In this way, search performance is improved by simply searching through the subset of images from the short-form video.

The output of the search engine can be input to the improving engine 434. In embodiments, the improving engine 434 can be a machine learning system, such as a neural network that is trainable via supervised learning techniques. In some embodiments, the improving engine 434 is trained based on user-provided feedback. The process depicted in FIG. 4 can be repeated as needed by the user to find images that meet his/her criteria.

In embodiments, the library further comprises images. In embodiments, the images within the library of short-form videos include line drawings, icons, or emojis. In embodiments, the searching identifies one or more images that correspond to the query. Embodiments can include presenting, to the user, the one or more images that correspond to the query. In embodiments, the library further comprises image frames from videos. In embodiments, the library of short-form videos is part of a proprietary video environment. The proprietary video environment can be a subscription service, a walled garden portal, or another suitable proprietary video environment.

In embodiments, the user comprises a system. The system can be a machine learning system that generates text queries and/or selects candidate synthesized images for use in an image-based search. In embodiments, the query includes an accuracy level of the searching. In embodiments, the presenting includes images from the library or images from frames of the presented short-form videos from the library of short-form videos that match the query. In embodiments, the presenting includes thumbnail representations. Embodiments can include sorting results of the searching. In embodiments, the sorting is based on relevance, text, at least one previous query, or metadata.

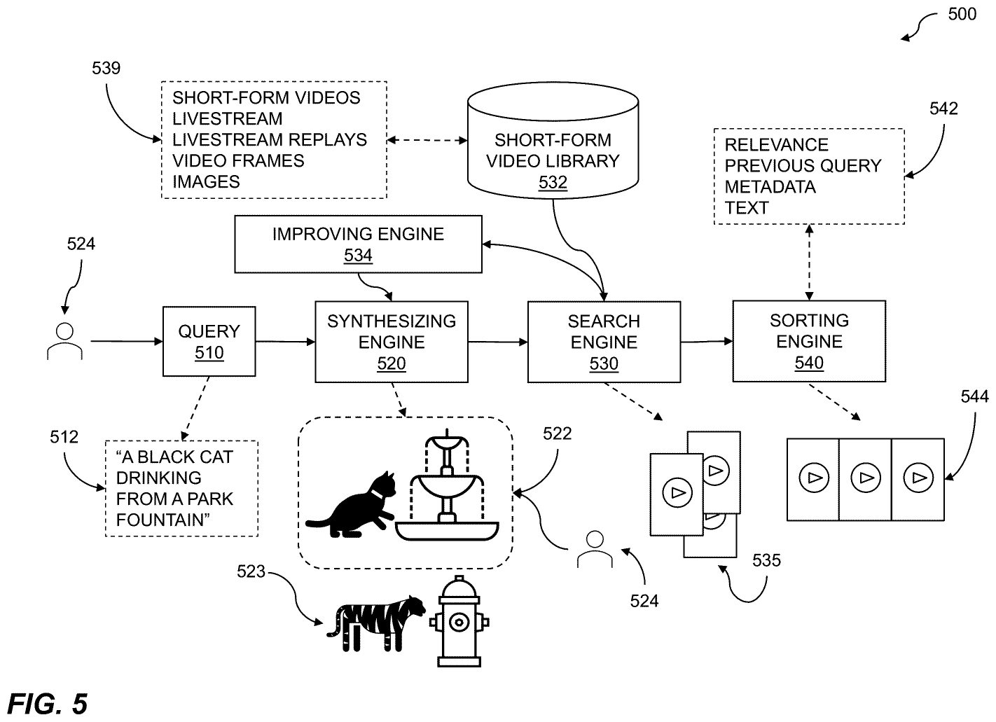

FIG. 5 is an infographic 500 for search with user selection. The flow depicted in FIG. 5 has similarities to that shown in FIG. 4, with a primary difference being the user selection of a synthesized image. A user 524 inputs a query 510. The query can be a text-based query. An example query 512 is shown which states, “A black cat drinking from a park fountain.”

The synthesizing engine 520 creates multiple synthesized images using a generative model, as previously described. The multiple synthesized images can be used as candidate input images for an image-based search. In this example, two synthesized images are produced based on the text query shown at 512. A first image 522 shows a cat near a fountain. A second image 523 shows a puma near a fire hydrant. A user 524 can then select which image of the multiple synthesized candidate input images to use for an image-based search. Thus, embodiments include generating multiple synthesized candidate images, and obtaining a selection for an image from the multiple synthesized candidate images to use as an input for an image-based search.

In the example, the user 524 selects image 522, and that image is provided to the search engine 530. Thus, the search engine 530 uses the output of the synthesizing engine 520 (the selected image 522) to perform a search within the short-form video library 532. The short-form video library has contents 539 which can include, but are not limited to, short-form videos, livestream videos, livestream replay videos, video frames, images, emojis, symbols, audio files, and/or other multimedia files. The output of the search engine 530 is multiple short-form videos 535. The short-form videos 535 are unsorted. The output of the search engine 530 is input to a sorting engine 540. The sorting engine 540 outputs the short-form videos 544 in a sorted manner. The sorting can be in a list, thumbnail grid, and/or other suitable representation. In embodiments, the sorting can be based on various criteria 542. The criteria can include, but is not limited to, text, metadata, previous query, and/or relevance. The text can include text within the short-form videos that is recognized via an optical character recognition (OCR) process. The metadata can include descriptive data associated with a short-form video. The relevance can be based on image characteristics such as colors, shapes, recognized objects, human faces, and other features shown in the images within the short-form video.

In some embodiments, every frame within a short-form video is searched to compare against the input image created by the synthesizing engine 520. In some embodiments, to save time, only certain frames within a short-form video are searched. In embodiments, only intra-coded frames (I-frames) are searched. In embodiments, each short-form video in the short-form video library 532 is indexed at periodic intervals (e.g., every five seconds) with a corresponding image from the short-form video also stored within the short-form video library. This indexing can be performed upon ingest of a video asset. In this way, search performance is improved by simply searching through the subset of images from the short-form video.

The output of the search engine can be input to the improving engine 534. In embodiments, the improving engine 534 can be a machine learning system, such as a neural network that is trainable via supervised learning techniques. In some embodiments, the improving engine 534 is trained based on user-provided feedback. The process depicted in FIG. 5 can be repeated as needed by the user to find images that meet his/her criteria.

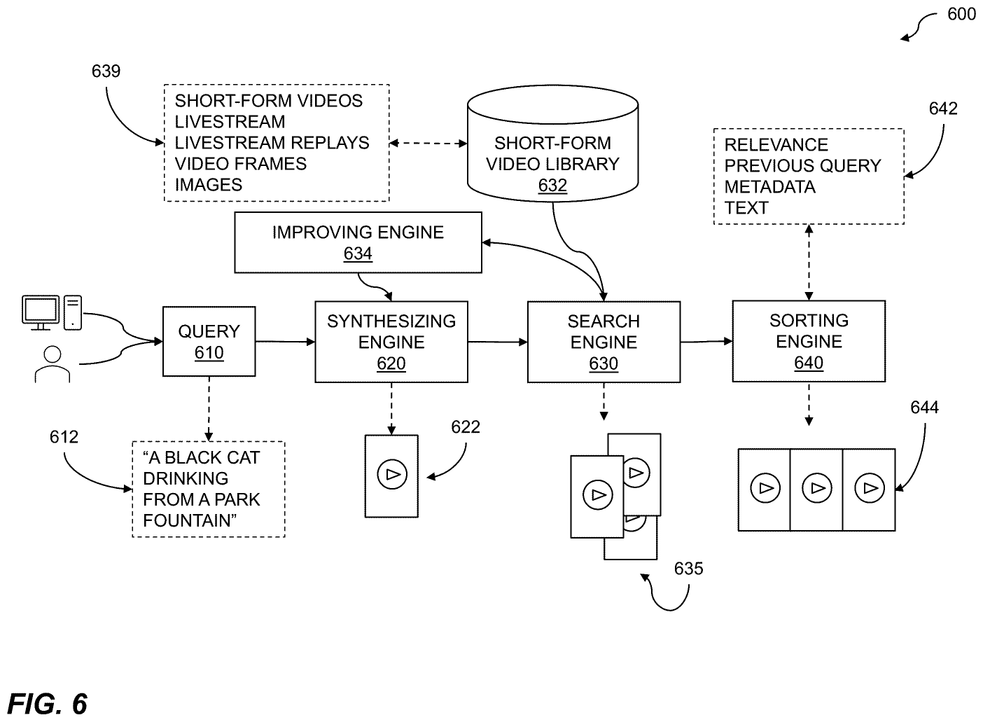

FIG. 6 is an infographic 600 for search based on video. The flow depicted in FIG. 6 has similarities to that shown in FIG. 4, with a primary difference being the use of a synthesized video. A user inputs a query 610. The query can be a text-based query. An example query 612 is shown which states, “A black cat drinking from a park fountain.”

The synthesizing engine 620 creates a synthesized video 622 comprising multiple synthesized images using a generative model. The generative model can be one of the generative models previously described. The synthesized video 622 is used as an input for image-based searching with a search engine 630. In some embodiments, every frame of the input video 622 is used as an input to search engine 630. In some embodiments, a subset of the frames is used. The subset can be a random sampling of frames. The subset can be a periodic sequence (e.g., every fifth frame of video). The subset can be based on scene changes within the synthesized video 622. In embodiments, the subset of images is input to the search engine 630.

The search engine 630 uses the output of the synthesizing engine 620 (the synthesized video 622) to perform a search within the short-form video library 632. The short-form video library 632 has contents 639 which can include, but are not limited to, short-form videos, livestream videos, livestream replay videos, video frames, images, emojis, symbols, audio files, and/or other multimedia files. The output of the search engine 630 is multiple short-form videos 635. The short-form videos 635 are unsorted. The output of the search engine 630 is input to sorting engine 640. The sorting engine 640 outputs the short-form videos 644 in a sorted manner. The sorting can be in a list, thumbnail grid, and/or other suitable representation. In embodiments, the sorting can be based on various criteria 642. The criteria can include, but is not limited to, text, metadata, previous query, and/or relevance. The text can include text within the short-form videos that is recognized via an optical character recognition (OCR) process. The metadata can include descriptive data associated with a short-form video. The relevance can be based on image characteristics such as colors, shapes, and other features within images within the short-form video.

In some embodiments, every frame within a short-form video is searched to compare against the input video 622 created by the synthesizing engine 620. In some embodiments, to save time, only certain frames within a short-form video are searched. In embodiments, only intra-coded frames (I-frames) are searched. In embodiments, each short-form video in the short-form video library 632 is indexed at periodic intervals (e.g., every five seconds) with a corresponding image from the short-form video also stored within the short-form video library. This indexing can be performed upon ingest of a video asset. In this way, search performance is improved by simply searching through the subset of images from the short-form video.

The output of the search engine 630 can be input to the improving engine 634. In embodiments, the improving engine 634 can be a machine learning system, such as a neural network, which is trainable via supervised learning techniques. In some embodiments, the improving engine 634 is trained based on user-provided feedback. The process depicted in FIG. 6 can be repeated as needed by the user to find images that meet his/her criteria. Some embodiments may provide an opportunity for a user to preview the synthesized video 622 before performing the search. In some embodiments, the synthesizing engine 620 may generate multiple candidate input videos, and the user can select which video(s) to use for performing an image-based search.

Embodiments can include creating a synthesized video using a generative model, wherein the generating is based on the obtaining. In embodiments, the searching is based on correspondence to the synthesized video resulting from the synthesizing. In embodiments, search results include a number of short-form videos to be presented to the user.

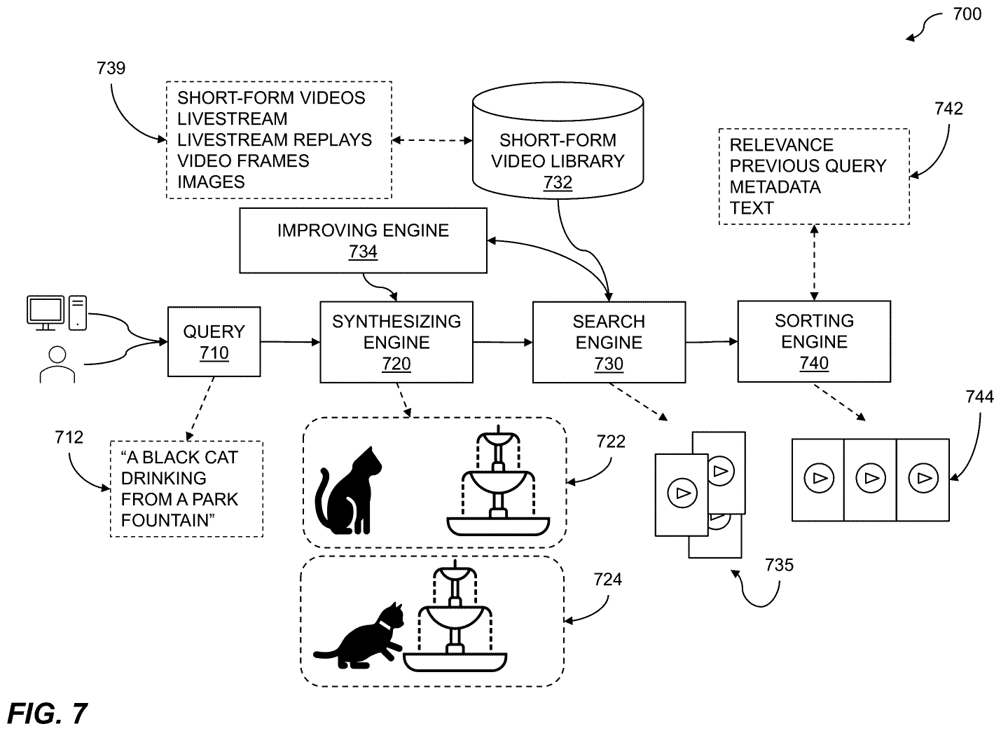

FIG. 7 is an infographic 700 for search based on picture sequence. A user inputs a query 710. The query can be a text-based query. An example query 712 is shown which states, “A black cat drinking from a park fountain.” The synthesizing engine 720 creates an image sequence using a generative model, as previously described. In this example, there is a first image 722 of a cat looking at a fountain, and a second image 724 of the cat getting closer to the fountain. The search engine 730 uses the output of the synthesizing engine 720 (the images 722 and 724) to perform a search within the short-form video library 732. In some embodiments, the user can provide a parameter for the similarity of the multiple synthesized images or, and/or the time difference between depictions within the multiple synthesized images. In the example shown, the time difference may be on the order of seconds, meaning that the time difference depicted between the image shown in 722 and that shown in 724 is on the order of seconds. If, for example, instead of a cat, the text query 712 was for a turtle drinking from a park fountain, the time difference may be selected to be on the order of minutes, since turtles may move slower than cats.

The short-form video library has contents 739 which can include, but are not limited to, short-form videos, livestream videos, livestream replay videos, video frames, images, emojis, symbols, audio files, and/or other multimedia files. The output of the search engine 730 is multiple short-form videos 735. The short-form videos 735 are unsorted. The output of the search engine 730 is input to sorting engine 740. The sorting engine 740 outputs the short-form videos 744 in a sorted manner. The sorting can be in a list, thumbnail grid, and/or other suitable representation. In embodiments, the sorting can be based on various criteria 742. The criteria can include, but is not limited to, text, metadata, previous query, and/or relevance. The text can include text within the short-form videos that is recognized via an optical character recognition (OCR) process. The metadata can include descriptive data associated with a short-form video. The relevance can be based on image characteristics such as colors, shapes, and other features within images within the short-form video. In embodiments, the metadata can include MPEG-7 metadata. MPEG-7 provides a variety of description tools, including color, texture, shape, and motion tools. These tools can enable the search and filtering of visual content (images, graphics, video) by dominant color or textures in particular regions of an image, or within the entire image.

In some embodiments, every frame within a short-form video is searched to compare against the input image sequence created by the synthesizing engine 720. In some embodiments, to save time, only certain frames within a short-form video are searched. In embodiments, only intra-coded frames (I-frames) are searched. In embodiments, each short-form video in the short-form video library 732 is indexed at periodic intervals (e.g., every five seconds) with a corresponding image from the short-form video also stored within the short-form video library. This indexing can be performed upon ingest of a video asset. In this way, search performance is improved by simply searching through the subset of images from the short-form video.

The output of the search engine 730 can be input to the improving engine 734. In embodiments, the improving engine 734 can be a machine learning system, such as a neural network that is trainable via supervised learning techniques. In some embodiments, the improving engine is trained based on user-provided feedback. The process depicted in FIG. 7 can be repeated as needed by the user to find images that meet his/her criteria.

In each of the above embodiments described in FIGS. 4-7, additional parameters, such as accuracy, may be used to further refine search results. In embodiments, the level of accuracy is a numerical parameter. In some embodiments, the level of accuracy ranges from zero to 100, with a higher number being more accurate. Some embodiments may include additional parameters besides a level of accuracy. Some embodiments may include a parameter for number of images to generate. Some embodiments may include a diversity factor. When multiple images are selected to be generated, the diversity factor is a measure of how different the generated images should be from each other. In some embodiments, an image size parameter may also be included. The image size parameter can include a measure of image size, in pixels, and/or bytes, to be generated. In embodiments, the synthesized image and the second synthesized image form a sequence based on the textual description. In embodiments, the sequence represents a video sequence.

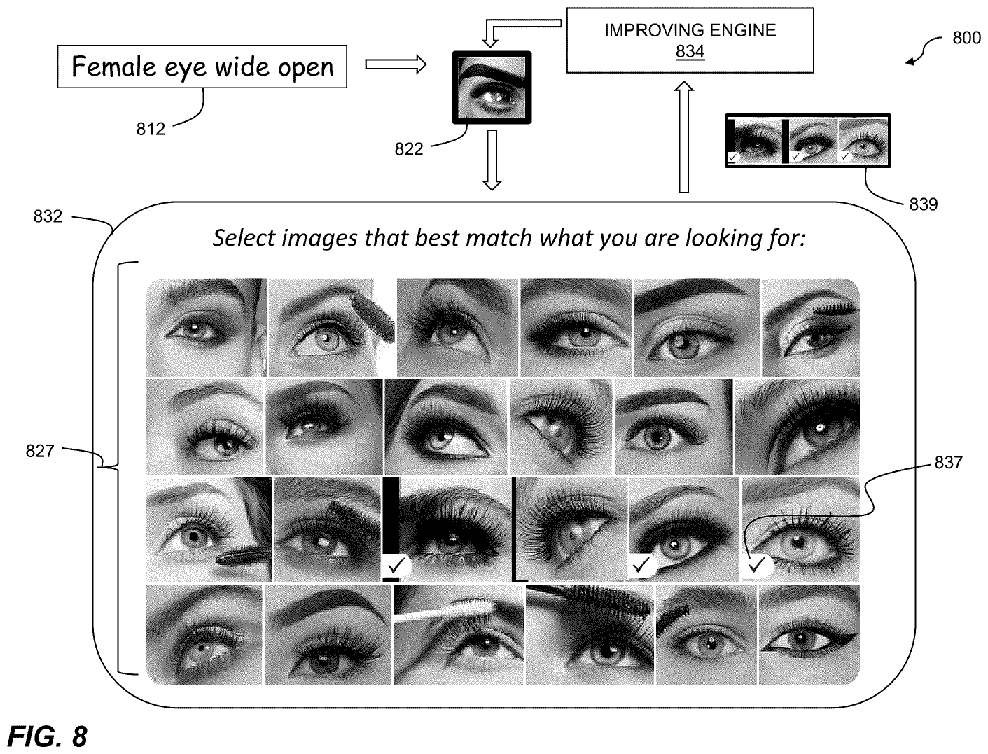

FIG. 8 is an infographic 800 for training an improving engine. A user-provided text-based query 812 is obtained. A synthesized image 822 is generated using a generative model, and the synthesized image 822 is used as an input for image-based search. Results 827 of the image-based search are displayed on a user interface 832. In some embodiments, the results 827 may be displayed in a sorted order, such as ranked from best match to worst match. In other embodiments, the results 827 may be displayed in a random order. In some embodiments, the number of returned results ranges from five to 30 results. Other embodiments may return more or fewer results. The user selects one or more images, as indicated generally at 837 by checkmarks in the lower left corner of selected images. The selected images, collectively indicated as 839, are provided to the improving engine 834, which may adjust weights of a neural network based on the selected images. With the adjusted weights, a new search can be performed based on input image 822. In this way, the search results can be improved by the training of the improving engine 834 using previous search results.

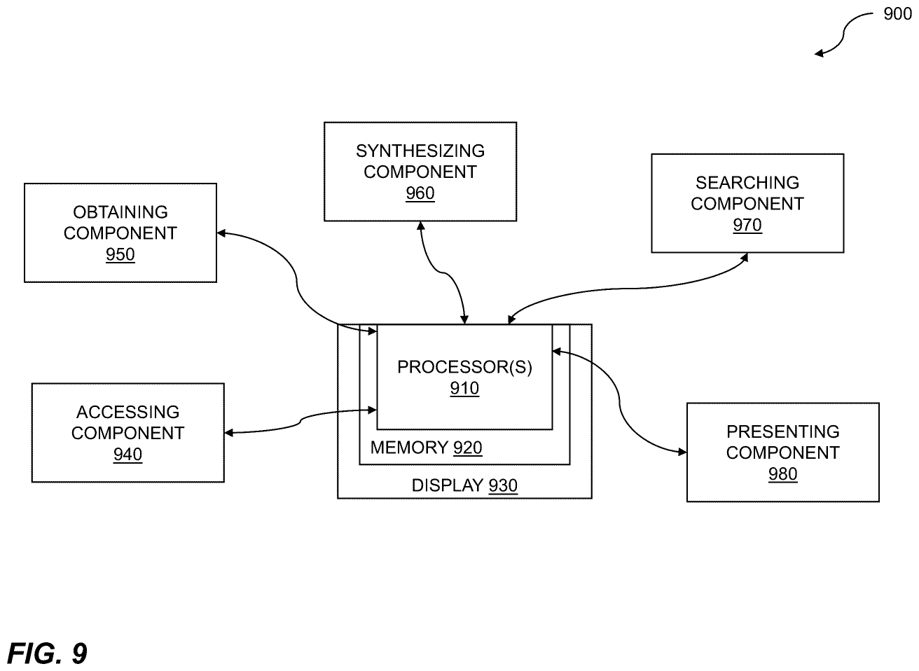

FIG. 9 is a system diagram for search using a generative model synthesized image. The system 900 can include one or more processors 910 attached to a memory 920 which stores instructions. The system 900 can include a display 930 coupled to the one or more processors 910 for displaying data, video streams, videos, video metadata, synthesized images, synthesized image sequences, synthesized videos, search results, sorted search results, search parameters, metadata, webpages, intermediate steps, instructions, and so on. In embodiments, one or more processors 910 are attached to the memory 920 where the one or more processors, when executing the instructions which are stored, are configured to: access a library of short-form videos; obtain, from a user, a query for a short-form video based on a textual description; synthesize an image, to create a synthesized image, using a generative model, wherein the synthesizing is based on the obtaining; search the library of short-form videos for the short-form video that corresponds to the synthesized image; and present, to the user, the short-form video from the library that corresponds to the query.

The system 900 can include an accessing component 940. The accessing component 940 can include functions and instructions for accessing one or more short-form videos from a short-form video server. The short-form video server can be a server accessible via a computer network, such as a LAN (local area network), WAN (wide area network), and/or the Internet. In some embodiments, the short-form video server may expose APIs for searching and retrieval of short-form videos. The accessing component 940 may utilize the APIs for obtaining short-form videos.

The system 900 can include an obtaining component 950. The obtaining component 950 can include a command-line interface, a data input field, and the like, for obtaining an input query text string. In some embodiments, the obtaining component 950 may include an audio capture device such as a microphone, and speech-to-text processing, to convert spoken words from a user into an input query text string. In some embodiments, natural language processing (NLP) techniques are performed on the search query text to perform disambiguation and/or entity detection. In embodiments, tokenization is performed on the search query text to identify parts of speech such as nouns, adjectives, verbs, adverbs, prepositions, and articles. The parts of speech are then used as input to a synthesizing component.

The system 900 can include a synthesizing component 960. The synthesizing component can include one or more generative models. The synthesizing component can be used to generate input images for an image-based search. The generative models can include, but are not limited to, a generative adversarial network (GAN), autoencoder, variational autoencoder, flow-based model, autoregressive model, and/or latent diffusion model. The synthesizing component 960 can generate multiple images. The multiple images can form a sequence. The multiple images can comprise a synthesized video. In some embodiments, the user is provided an opportunity to preview and accept/reject the output of the synthesizing component 960 prior to performing an image-based search.

The system can include a searching component 970. The searching component 970 can perform image-based searching on short-form videos. The searching component 970 may perform multiple steps, including, but not limited to, video segmentation, feature extraction, feature matching, and/or geometric verification. The searching component may utilize a variety of techniques for video searching, including, but not limited to, convolutional neural networks (CNNs), hashing over Euclidean space (HER), Bloom filtering, and/or a visual weighted inverted index. The searching component can retrieve one or more assets from a short-form video library based on the input images. The assets can include, but are not limited to, short-form videos, livestream videos, livestream replay videos, video frames, images, 360-degree videos, 3D videos, and/or virtual reality videos.

The system can include a presenting component 980. The presenting component 980 may utilize the display 930 to display search results. Alternatively, the presenting component 980 may provide an output displayable on a remotely connected client device. The output can include HTML, output and/or remote viewing output such as X-windows or remote desktop protocols. In some embodiments, the presenting component 980 outputs JSON-formatted data being sent to a specified URL. Other embodiments may include utilization of RESTful APIs, and/or other suitable protocols and techniques for interacting with a remote client device. The presenting component 980 may provide multiple synthesized images from the synthesizing component 960, and allow for user selection of which synthesized image(s) are used as an input to an image-based search.

The system 900 can include a computer program product embodied in a non-transitory computer readable medium for searching, the computer program product comprising code which causes one or more processors to perform operations of: accessing a library of short-form videos; obtaining, from a user, a query for a short-form video based on a textual description; synthesizing an image, to create a synthesized image, using a generative model, wherein the synthesizing is based on the obtaining; searching the library of short-form videos for the short-form video that corresponds to the synthesized image; and presenting, to the user, the short-form video from the library that corresponds to the query.

The system 900 can include a computer system for searching comprising: a memory which stores instructions; one or more processors coupled to the memory, wherein the one or more processors, when executing the instructions which are stored, are configured to: access a library of short-form videos; obtain, from a user, a query for a short-form video based on a textual description; synthesize an image, to create a synthesized image, using a generative model, wherein the synthesizing is based on the obtaining; search the library of short-form videos for the short-form video that corresponds to the synthesized image; and present, to the user, the short-form video from the library that corresponds to the query.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for searching comprising:
accessing a library of short-form videos;
obtaining, from a user, a query for a short-form video based on a textual description;
synthesizing an image, to create a synthesized image, using a generative model, wherein the synthesizing is based on the obtaining;
searching the library of short-form videos for the short-form video that corresponds to the synthesized image; and
presenting, to the user, the short-form video from the library that corresponds to the query.

2. The method of claim 1 wherein the generative model is based on a generative adversarial network (GAN), a variational autoencoder (VAE), a flow-based model, an autoregressive model, or latent diffusion.

3-5. (canceled)

6. The method of claim 1 wherein the synthesizing includes creating a second synthesized image based on the generative model.

7. The method of claim 6 further comprising selecting, by the user, between the synthesized image and the second synthesized image.

8. The method of claim 7 wherein the searching is based on the selecting.

9. The method of claim 6 further comprising evaluating results of searches based on the synthesized image and the second synthesized image.

10. The method of claim 9 wherein the presenting is based on the evaluating.

11. The method of claim 6 wherein the searching includes correspondence to a second synthesized image.

12. The method of claim 11 wherein the synthesized image and the second synthesized image form a sequence based on the textual description.

13. The method of claim 12 wherein the sequence represents a video sequence.

14. The method of claim 1 further comprising improving search results, wherein the improving is based on a second search iteration with the presented short-form video.

15. The method of claim 14 wherein the second search iteration includes a second synthesized image based on the generative model.

16. The method of claim 1 further comprising creating a synthesized video using a generative model, wherein generating is based on the obtaining.

17. The method of claim 16 wherein the searching is based on correspondence to the synthesized video resulting from the synthesizing.

18. The method of claim 1 wherein the library further comprises images.

19. The method of claim 18 wherein the images within the library of short-form videos include line drawings, icons, or emojis.

20. The method of claim 18 wherein the searching identifies one or more images that correspond to the query.

21. The method of claim 20 further comprising presenting, to the user, the one or more images that correspond to the query.

22. The method of claim 1 wherein the library further comprises image frames from videos.

23. The method of claim 1 wherein the library of short-form videos is part of a proprietary video environment.

24. The method of claim 1 wherein the user comprises a system.

25. The method of claim 1 wherein the query includes an accuracy level of the searching.

26. The method of claim 1 wherein search results include a number of short-form videos to be presented to the user.

27. The method of claim 1 wherein the presenting includes images from the library or images from frames of the presented short-form video from the library of short-form videos that match the query.

28. The method of claim 1 further comprising sorting results of the searching.

29. (canceled)

30. A computer program product embodied in a non-transitory computer readable medium for searching, the computer program product comprising code which causes one or more processors to perform operations of:
accessing a library of short-form videos;
obtaining, from a user, a query for a short-form video based on a textual description;
synthesizing an image, to create a synthesized image, using a generative model, wherein the synthesizing is based on the obtaining;
searching the library of short-form videos for the short-form video that corresponds to the synthesized image; and
presenting, to the user, the short-form video from the library that corresponds to the query.

31. A computer system for searching comprising:
a memory which stores instructions;
one or more processors coupled to the memory wherein the one or more processors, when executing the instructions which are stored, are configured to:
access a library of short-form videos;
obtain, from a user, a query for a short-form video based on a textual description;
synthesize an image, to create a synthesized image, using a generative model, wherein the synthesizing is based on obtaining;
search the library of short-form videos for the short-form video that corresponds to the synthesized image; and
present, to the user, the short-form video from the library that corresponds to the query.
